(19) United States
(12) Patent Application Publication
(10) Pub. No.: US 2006/0282844 A1
(43) Pub. Date: Dec. 14, 2006

(54) LATCH MECHANISM OF AN OPTICAL DISK DRIVE

(76) Inventors: Jen-Chen Wu, Taoyuan County (TW); Yao-Ting Kuo, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/421,485

(22) Filed: Jun. 1, 2006

(30) Foreign Application Priority Data
Jun. 12, 2005 (TW) 094119734

(51) Int. Cl. G11B 7/00

(52) U.S. Cl. 720/673

(57) ABSTRACT

The present invention provides a letch mechanism of an optical disk drive, which disposes a frame including an openning on the tray. A shape memory alloy is fixed in the frame and includes a movable end stretching out of the openning. A hook portion is equipped with a pivot and a hook connected with the movable end. A spring is attached to the pivot and extends one end to fasten on the hook portion. A locking pin is disposed on the position corresponding to the hook.

### BACKGROUND OF THE INVENTION

1. Field of the Invention

The present invention relates to a latch mechanism of an optical disk drive, and more particularly to a latch mechanism capable of preventing a tray from ejecting out of the optical disk drive due to inertia when the optical disk drive is violently impacted.

2. Description of the Prior Art

I when an optical disk drive experiences a great impact, the latch locked a tray unlocks due to inertia generated by the impact to cause the tray to eject. As schematically shown in FIG. 1, an electromagnetic actuator of a conventional optical disk drive is in a locking situation. The electromagnetic actuator 11 with a magnetic core 14 to pass through a spring 15 is disposed on a tray 10. When switching off the electromagnetic actuator 11, the spring 15 pushes the magnetic core 14 to drive a hook portion 12 to lock a locking pin 13 so that the tray 10 is locked in the optical disk drive 1. The bigger force the spring 15 has, the better the locking reliablity of the tray 10 is. Please refer to FIG. 2, when switching on the electromagnetic actuator 11, the magnet gerenerated by the electromagnetic actuator 11 pulls back the magnetic core 14 to compress the spring 15 and move the hook portion 12 to unlock the locking pin 13 to release the tray 10 out of the optical disk drive 1. Furthermore, an emergence ejection part 16 is disposed beside the hook portion 12. when pushing the emergence ejection part 16, the hook portion 12 is driven to unlock the locking pin 13 so that the tray may be rleased out of the optical disk drive 1 for maintainence. However, the electromagnetic actuator 11 wastes more power because it needs to resist the force of the spring 15 to release the tray 15 from the locking pin 13. It is especially unfavorable to portable optical disk drive.

Besides, the magnetic core 14 floats in the electromagnetic actuator 11 due to the restriction of the spring 15. When the optical disk drive 1 experiences an impact, the magnetic core 14 has enough weight to form inertia capable of compressing the spring 15 to pull back the magnetic core 14 so that the hook portion 12 unlocks the locking pin 13 to release the tray 10 out of the optical disk drive 1 to damage the disc and components of the the optical disk drive 1. Therefore, it needs to solve the problem of how to prevent the tray from unlocking for an optical disk drive when the optical disk drive 1 experiences an impact.

### SUMMARY OF THE INVENTION

It is one object of the invention to provide a letch mechanism of an optical disk drive in which a shape memory alloy is used to drive a hook portion to lock or unlock a locking pin. When the optical disk drive experiences an impact, the shape memory alloy is too light to generate enough inertia which can disengage from the locking pin to prevent a tray from coming off the optical disk drive.

It is another object of the invention to provide a letch mechanism of an optical disk drive in which a shape memory alloy disengages the a hook portion from a locking pin to reduce power comsumption dut to the feature of changing the shape based on conditions.

It is further object of the invention to provide a letch mechanism of an optical disk drive which constructs a simple letch module with a function of an emergency ejection to simplize the structure.

For achieving the above objects, the present invention provides a letch mechanism of an optical disk drive, which disposes a frame including an openning on the tray. A shape memory alloy is fixed in the frame and includes a movable end stretching out of the openning. A hook portion is equipped with a pivot and a hook connected with the movable end. A spring is attached to the pivot and extends one end to fasten on the hook portion. A locking pin is disposed on the position corresponding to the hook.

Further features and advantages of the invention, as well as the method and operation of various embodiments of the invention, are described in detail below with reference to the accompanying drawings

### BRIEF DESCRIPTION OF THE DRAWINGS

FIG. 1 is a schematic view of a conventional electromagnetic actuator in a locking situation.

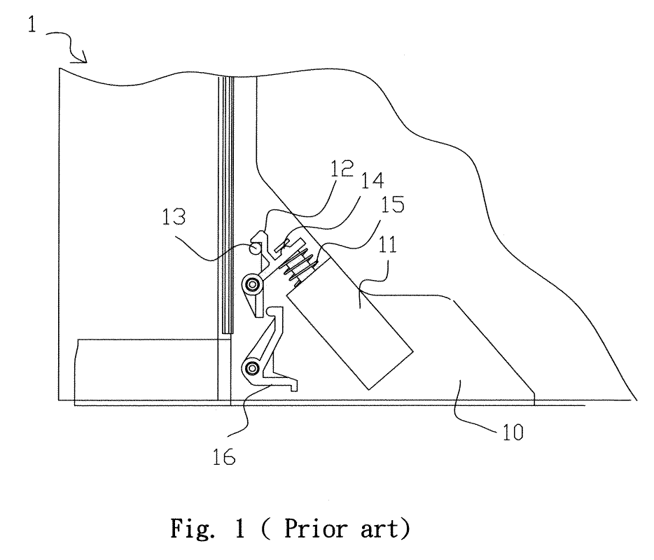

FIG. 2 is a schematic view of a conventional electromagnetic actuator in an unlocking situation.

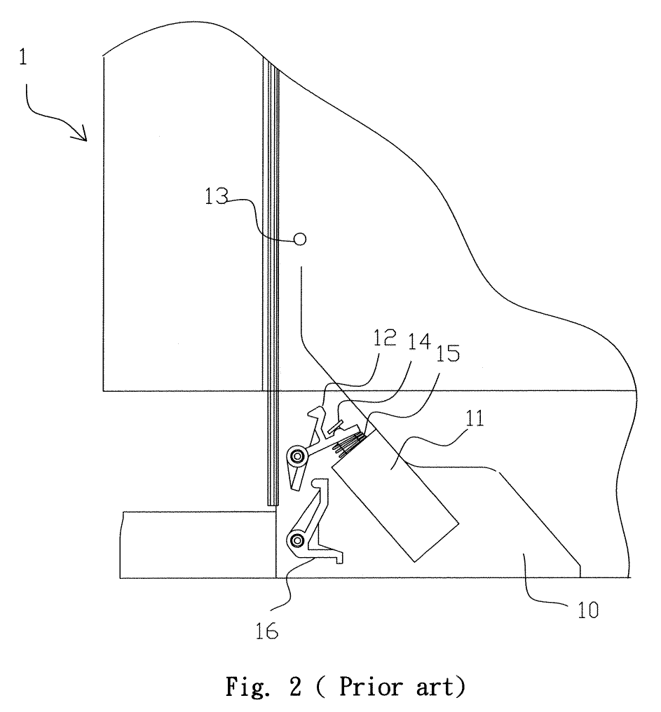

FIG. 3 is a schematic view of the letch mechanism of the present invention in a locking situation.

FIG. 4 is a schematic view of the letch mechanism of the present invention in an unlocking situation.

### DETAILED DESCRIPTION

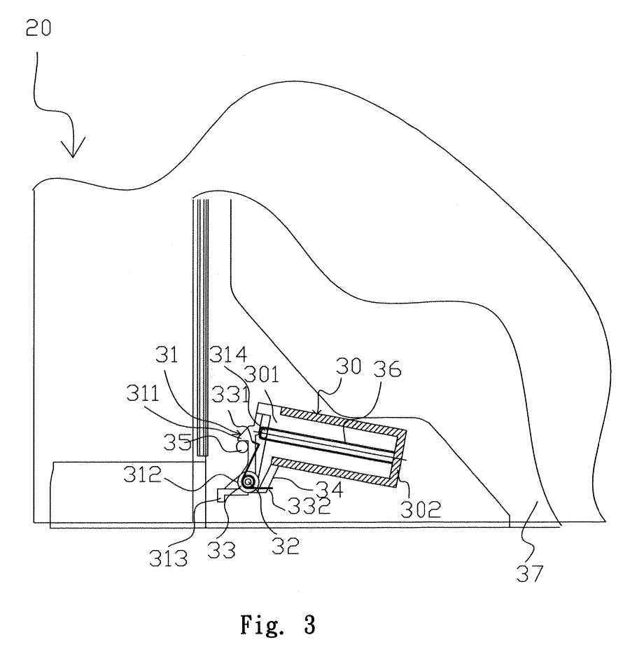

Referring to FIG. 3, a schematic view of a letch mechanism of the present invention is shown. The letch mechanism, applied in an optical disk drive 20 with a tray 37, includes a frame 30, a hook portion 31, a fastening part 32, a spring 33, an extension part 34, a locking pin 35, and a shape memory alloy 36.

The frame 30 disposed on the tray 37 includes an openning 30 and a bottom 302. The hook portion 31 includes a hook 311 disposed at one end, a pivot 312 at the middle, and an ejection part 313 at the other end. The fastening part 32 fastens the pivot 312 of the frame 30 on the tray 37. The spring 33 puts around the fastening part 32, and two ends of the spring 33 extend outward to form two spring wires 331, 332 which have an angle between them. The spring wire 331 is fastened to the hook portion 31, and the spring wire 332 is fastened to the extension part 34 extended from the frame 30. The spring 33 enables the hook 311 to lock the locking pin 35 on the optical disk drive 20, such as a lower casing. One end of the shape memory alloy 36 is fixed on the bottom 302, and the other end stretches out of the openning 301 to form a movable end. Th movable end movably connected to a hole 314 on the hook portion 31. The shape memory alloy 36 made of memory alloy is light, and deforms its shape with a change of length when the current passes through it.

When turning off the letch mechanism, i.e. the current does not pass through the shape memory alloy 36, the shape memory alloy 36 is in a stretch situation. One end of the shape memory alloy 36 is fixed on the bottom 302, and the other end is loose to enable the spring 33 to compress the hook portion 31. Therefore, the hook 311 engages the locking pin 35 to lock the tray 37 in the optical disk drive 20.

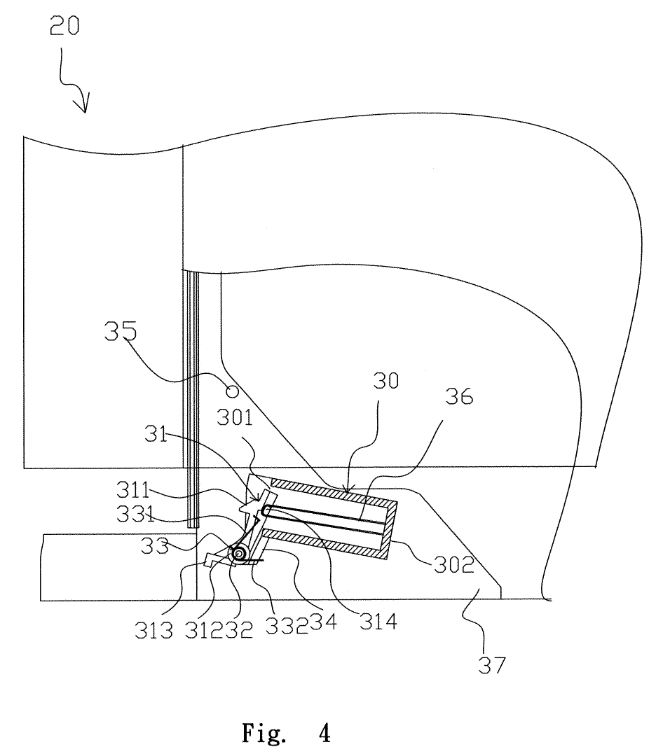

Please refer to FIG. 4, the schematic view shows the letch mechanism of the present invention in unlocking situation. When turning on the letch mechanism, the current passes through the shape memory alloy 36 to change the situation of the shape memory alloy 36. The shape memory alloy 36 generates a shape change to shorten its length. Since one end of the shape memory alloy 36 is fixed on the bottom 302, the other end resists the force of the spring 33 to pull the hook portion 31 inward. The hook 331 of the hook portion 31 disengages the locking pin 35 to release the tray 37 out of the optical disk drive 20.

Therefore, when the letch mechanism locking the tray 37 in the optical disk drive 20 experiences a great impact, the shape memory alloy 36 can not move not only since it is fixed on the frame, but also the shape memory alloy 36 generates such smaller inertia due to the lightness that the small inertia can not resist the force of the spring 33 to disengage the hook 311 from the locking pin 35. Then, the reliability of a locking situation is certainly held to protect the optical disk drive and the disc. Furthermore, it only needs smaller current to change the situation of the shape memory alloy 36 so as to reduce the power consumption and raise the energy efficiency.

Besides, when the letch mechanism proceeds to eject the disc in an emergency, a stick is used to push the ejection part 313 of the hook portion 31 to resist the force of the spring 33 so that the hook portion 31 may rotate around the pivot 312. Since the movable end of the shape memory alloy 36 just is movable fastened the hole 314 of the hook portion 31, the hook 311 is disengaged from the locking pin 35 to release the tray 37 out of the optical disk drive 20 for maintence, inspection and picking up the disk. Therefore, the present invention simplifies the structure of the emergency ejection on the hook portion 31, and forms a compact module with the frame 30, the shape memory alloy 36, and the spring 33. The present invention not only has the functione of emergency ejection, but also simplifies the structure to reduce the production cost and increase the adopable flexibility. At the same concepts, the component position of the present invention can be changed each other. For exemple, the letch mechanism is disposed on the lower casing, the locking pin is disposed on the tray, and the locking and unlocking fucntions is still kept.

Therefore, the present invention constructs the leth mechanism with simple components, and replaces the conventional electromagnetic actuator with the shape memory alloy 36 so as to avoid the defects which is released the tray out of the optical disk drive due to inertia when the optical disk drive experience a great impact. Meanwhile, the components of the invention are very simple and cheap for producing.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A letch mechanism of an optical disk drive, comprising:
a frame including an openning;
a shape memory alloy fixed in the frame, which includes a movable end stretching out of the openning;
a hook portion equipped with a pivot and a hook connected with the movable end;
a spring which is attached to the pivot and extends one end to fasten on the hook portion; and
a locking pin disposed on the position corresponding to the hook.

2. The letch mechanism of an optical disk drive of claim 1, wherein the optical disk drive further comprises a tray on which the frame, the shape memory alloy, the hook portion and the spring are disposed, and the locking pin is disposed on the optical disk drive.

3. The letch mechanism of an optical disk drive of claim 2, wherein the optical disk drive further comprises a lower casing on which the locking pin is disposed.

4. The letch mechanism of an optical disk drive of claim 1, wherein the optical disk drive further comprises a tray on which the locking pin is disposed, and the frame, the shape memory alloy, the hook portion and the spring are disposed on the optical disk drive.

5. The letch mechanism of an optical disk drive of claim 4, wherein the optical disk drive further comprises a lower casing on which the frame, the shape memory alloy, the hook portion and the spring are disposed.

6. The letch mechanism of an optical disk drive of claim 1, wherein the frame further comprises a bottom on which one end of the shape memory alloy is fixed.

7. The letch mechanism of an optical disk drive of claim 1, wherein the hook portion further comprises an ejection part.

8. The letch mechanism of an optical disk drive of claim 1, wherein the frame further comprises an extension part to which the spring extends the other end to fasten.

9. The letch mechanism of an optical disk drive of claim 1, wherein the hook portion further comprises a hole to connect with the shape memory alloy.

10. The letch mechanism of an optical disk drive of claim 1, wherein the shape memory alloy is the material of memory alloys.

11. The letch mechanism of an optical disk drive of claim 1, wherein the shape memory alloy generates the change of length when the current passes through the shape memory alloy.
